(19) United States
(12) Patent Application Publication
(10) Pub. No.: US 2023/0315786 A1
(43) Pub. Date: Oct. 5, 2023

(54) SUB-GRAPH MATCHING POLICY DETERMINATION METHOD, SUB-GRAPH MATCHING METHOD, SUB-GRAPH COUNTING METHOD AND CALCULATION DEVICE

(71) Applicant: Tsinghua University, Beijing (CN)

(72) Inventors: Jidong Zhai, Beijing (CN); Tianhui Shi, Beijing (CN); Mingshu Zhai, Beijing (CN); Yi Xu, Beijing (CN)

(21) Appl. No.: 18/017,875

(22) PCT Filed: Aug. 27, 2020
(86) PCT No.: PCT/CN2020/111587

§ 371 Date: Jan. 25, 2023

(51) Int. Cl. G06F 16/901; G06F 18/22

(52) U.S. Cl. CPC G06F 16/9024; G06F 18/22

(57) ABSTRACT

Disclosed are a subgraph matching strategy determining method, a subgraph matching method, a counting method, and a device; the matching strategy determining method includes: obtaining a pattern; generating a plurality of restriction sets, for the pattern, each restriction set being capable of eliminating all other automorphisms different from the pattern per se in the automorphisms of the pattern; obtaining a plurality of search order schedules, for the pattern; combining the plurality of restriction sets and the plurality of search order schedules, each combination being referred to as a configuration; using a performance prediction model to predict a computation amount of a subgraph matching algorithm corresponding to each configuration, and determining one or more configurations as a subgraph matching strategy, based on the predicted computation amount. The present disclosure can determine an optimized subgraph matching strategy, reduce redundant computations in subgraph matching, and efficiently and accurately find matched subgraphs. With respect to applications of matched subgraph counting, a subgraph counting schedule using Inclusion-Exclusion Principle to directly count is proposed, which greatly improves computing efficiency.

### TECHNICAL FIELD

The present disclosure generally relates to subgraph matching in graph data processing, and more particularly, to a subgraph matching strategy determining method, a subgraph matching method, a subgraph counting method, and a computing device.

### BACKGROUND

In today’s society, graph data and graph algorithms are widely used in many fields, such as social networks, bioinformatics, and fraud detection. With the increasing amount of graph data, processing and analyzing graphs efficiently become more and more critical. Graph mining is a class of very important graph analysis problem, which is intended to discover complex structural patterns in graph data. High performance distributed graph mining is extremely challenging to design. The subgraph matching problem is the most typical and common graph mining problem. With increase of graph data scale, the number of potential patterns instances may increase exponentially, resulting in an exponential increase in searching space, computation amount, and intermediate data amount. Subgraph matching usually has two applications, one is to find all subgraphs matching the pattern, and the other is to count all subgraphs matching the pattern.

At present, there are some researches on subgraph matching system. The methods used by most subgraph matching systems may be represented as multi-layer nested loops or depth-first search, among which the representative systems with high performance include AutoMine introduced in non-patent document 1 and GraphZero introduced in non-patent document 2.

There are two main problems in the methods used in current subgraph matching systems. First of all, because the subgraph pattern may be symmetric, a same subgraph may be repeatedly calculated many times (the repeatedly calculated subgraphs are usually referred to as automorphisms), which leads to a large amount of redundant computations. In order to reduce the redundant computations of searching automorphisms, the graph matching system will use some methods to eliminate automorphisms. For example, GraphZero uses a method based on group theory, that is, generating a set of restrictions for the pattern, and using these restrictions in a search procedure, so that automorphisms may be eliminated.

### SUMMARY

Through experiments, an inventor finds that there may be a plurality of sets of different restrictions on a pattern; using any set of restrictions may completely eliminate automorphisms, but using different restriction sets has a great impact on system performance. However, the method used by existing graph matching systems (e.g., GraphZero) can only generate one set of restrictions for a pattern. Secondly, the inventor believes that there are many different search orders for a pattern. Although answers from different search orders are the same, their performance varies greatly. Therefore, the subgraph matching system also needs to predict performance of different search orders and choose between different search orders. For example, Peregrine in non-patent document 3 uses minimum connected vertex coverage to find a high-performance search order. However, the predicting methods used in the existing graph matching systems are relatively simple; when the pattern is large and complex, the existing predicting methods cannot choose the best search order.

According to one aspect of the present disclosure, there is provided a subgraph matching strategy determining method for finding a subgraph matching a pattern p in a data graph, including: obtaining a pattern p; generating a plurality of restriction sets R, for the pattern p, each restriction set being capable of eliminating all other automorphisms different from the pattern per se in the automorphisms of the pattern; obtaining a plurality of search order schedules S, for the pattern p; combining the plurality of restriction sets R and the plurality of search order schedules S, each combination being referred to as a configuration C; using a performance prediction model to predict a computation amount of a subgraph matching algorithm corresponding to each configuration C, and determining one or more configurations as a subgraph matching strategy, based on the predicted computation amount. Usually, a configuration with a minimum computation amount is determined as the subgraph matching strategy.

Optionally, the generating a plurality of restriction sets R includes: finding all automorphisms of the pattern P; writing a permutation corresponding to each automorphism as a product of disjoint cycles, based on group theory, wherein, permutations corresponding to all the automorphisms form a permutation group; for each permutation in the group, if a 2-order cycle (2-cycle) can be found therein, appending a partial order restriction between two vertices of the 2-cycle; and obtaining the plurality of restriction sets, based on a combination of these partial order restrictions, wherein, each restriction set is capable of eliminating all the automorphisms of the pattern.

Optionally, the generating a plurality of restriction sets R includes: step 1: finding all the automorphisms of the pattern P, step 2: writing a permutation corresponding to each automorphism in a form of product of disjoint cycles, based on group theory, wherein, permutations corresponding to all the automorphisms form a permutation group; step 3: selecting a 2-cycle of a permutation in the permutation group; step 4: appending a partial order restriction between two vertices of the selected 2-cycle, and appending the partial order restriction to the current restriction set; step 5: using the current restriction set, to eliminate some permutations in the permutation group; step 6, repeating steps 3 to 5 until there is only one permutation in the permutation group; step 7: verifying the correctness of the current restriction set; if correct, a validate restriction set is found; step 8. repeating steps 3 to 7 by traversing all 2-cycles in the group.

Optionally, the using the current restriction set, to eliminate some permutations in the permutation group, includes: for each permutation perm in the permutation group, judging whether the permutation may be eliminated by the current restriction set, including: for each restriction in the current restriction set, regarding the restriction as two directed edges and adding the two edges to an initially empty directed graph g, representing the two vertices of the restriction respectively as x and y, then connecting a directed edge is from vertex x to vertex y in the directed graph g, that is, connecting a directed edge from perm[x] to perm[y]; if the directed graph g is a directed acyclic graph, the permutation perm is not eliminated; otherwise, the permutation perm is eliminated.

Optionally, the subgraph matching strategy determining method further includes verifying whether a restriction set is validate; if validate, preserving the restriction set; otherwise, discarding the restriction set.

Optionally, the verifying whether a restriction set is validate includes: assuming that the pattern p includes n vertices, executing the subgraph matching algorithm with the restriction set on a complete graph of n vertices, recording the number of subgraphs obtained as ans_{with}; executing the subgraph matching algorithm without any restriction on the complete graph of n vertices, recording the number of subgraphs obtained as ans_{without}; if ans_{with} = ans_{without} /automorphisms_count, it is verified that the current restriction set is capable of correctly eliminating all redundant computations caused by automorphisms, and is validate; otherwise, the restriction set is invalidate, where, automorphisms_count is the number of automorphisms of the pattern p.

Optionally, the obtaining a plurality of search order schedules S, for the pattern p, includes: assuming that a given pattern has n vertices, generating all n! possible search orders; discarding a search order in which an ith vertex (1<i<=n) is disconnected from the first (i-1) vertices in the pattern among the search orders; and discarding a search order in which the last k vertices are not pairwise disconnected in the pattern among the search orders, where, k is the maximum number of vertices pairwise disconnected in the pattern.

Optionally, the performance prediction model is based on a 3-element ring, and estimation of a set size of an intersection of a plurality of sets needs to be used, wherein, a set size of an intersection of n neighbor sets is estimated as:

$$\left|{\text{V}}_{\text{G}}\right| \times {\text{p}}_{1} \times {p}_{2}^{n - 1} ,$$

Where,

$${\text{p}}_{1} = \frac{2 \times \left|{E}_{G}\right|}{{\left|{V}_{G}\right|}^{2}} , {\text{p}}_{2} = \frac{t r i \_ c n t \times \left|{V}_{G}\right|}{{\left(2 \times \left|{E}_{G}\right|\right)}^{2}} ,$$

and E_{G}, V_{G}, tri_cnt are respectively the numbers of edge sets, vertex sets and 3-element ring subgraphs in the data graph.

Optionally, the performance prediction model is:

$$\begin{matrix}{\text{cost}}_{i} = \\ \left\{\begin{matrix}{l}_{i} \times \left(1 - {f}_{i}\right) \times \left({c}_{i} + c o s {t}_{i + 1}\right) , f o r 1 \leq i \leq n - 1 \\ {l}_{i} \times \left(1 - {f}_{i}\right) , f o r i = n\end{matrix}\right)\end{matrix}$$

Where, n is the number of vertices in the pattern, costᵢ is the total cost of the ith loop, lᵢ is the loop size, fᵢ is the probability that one subgraph is filtered out by a restriction, cᵢ is the computation overhead of the intersection operations, and in the computation of lᵢ and cᵢ, the set size of the intersection of a plurality of sets is estimated.

According to another aspect of the present disclosure, there is provided a subgraph matching method for searching a subgraph matching a pattern p in a data graph, including: obtain a subgraph matching strategy by using the foregoing subgraph matching strategy determining method; and using the obtained subgraph matching strategy to find a subgraph matching the pattern p in the data graph.

Optionally, the subgraph matching method is applied to social networks, bioinformatics, and fraud detection.

According to another aspect of the present disclosure, there is provided a subgraph counting method for determining the number of subgraphs matching a pattern p in a data graph, including: obtaining a subgraph matching strategy by using the foregoing subgraph matching strategy determining method; and using Inclusion-Exclusion Principle for counting, considering that there is no edge connected between the last k vertices searched in the pattern, and in a corresponding subgraph matching strategy, there is no dependence between the last k loops.

Optionally, in the foregoing subgraph counting method, let Sᵢ be a loop set corresponding to the ith vertex in the last k vertices (i.e., a set where the ith loop in the innermost k loops traverses),

$$\begin{matrix}{\text{S}}_{I E P} = \left\{\left({e}_{1} , {e}_{2} , … , {e}_{k}\right) \left|∀ 1 \leq i \leq \text{k}\right) \text{s} \text{.t} \text{.} {\text{e}}_{i} ∈ {S}_{i} a n d ∀ 1 \leq i , j \leq \right) \\ \left(k s . t . {e}_{i} \neq {e}_{j}\right\}\end{matrix}$$

S_{IEP} means that each element of a k-element group consisting of the k vertices and the first (n-k) vertices that have been determined are capable of forming a subgraph matching the pattern, so counting the matched subgraph is equivalent to calculating a set size of S_{IEP};

A complement transforming method is used, to obtain:

$${\text{S}}_{I E P} = {\text{S}}_{1} \times {\text{S}}_{2} \times … \times {\text{S}}_{k} - \left\{\left({e}_{1} , {e}_{2} , … , {e}_{k}\right) \left|∃ 1 \leq i , j \leq k s . t . {e}_{i} = {e}_{j}\right)\right\} .$$

The set size of S₁ × S₂ × ... × Sₖ can be directly calculated according to the multiplication principle, while the set size of {(e₁, e₂, ..., eₖ|∃1 ≤ i, j ≤ k s.t. eᵢ = eⱼ} can be calculated through the Inclusion-Exclusion Principle, and the set size of S_{IEP} can be obtained by subtracting the two.

According to another aspect of the present disclosure, there is provided a computing device, including: a processor; and a memory, having computer executable instructions stored thereon; wherein, the instructions, when executed by the processor, execute the foregoing method.

According to another aspect of the present disclosure, there is provided a computer readable storage medium, having computer executable instructions stored thereon; wherein, the instructions, when executed by the processor, execute the foregoing method.

The subgraph matching method for eliminating redundant computations according to the embodiment of the present disclosure adopts a 2-cycle based restriction generation algorithm, which may generate a variety of different restriction sets, each of which is capable of completely eliminating automorphisms, and performance caused by using different sets is different, which also provides more possible optimization opportunities for subsequent performance prediction; in the 2-phase search order generating method, some search orders whose performance is obviously low may be discarded in advance to reduce the cost of the performance prediction phase; the performance prediction model based on the 3-element ring may predict performance of different configurations more accurately, so as to reduce redundant computations in the subgraph matching algorithm.

With respect to applications that only need counting the number of subgraphs matching the pattern in the graph data, but not caring about the specific subgraphs matching the pattern, the inventor proposes a subgraph counting schedule by using the Inclusion-Exclusion Principle to directly count, so as to reduce redundant computations, which greatly improves computing efficiency.

Non-patent documents cited herein:

[1] Mawhirter, Daniel, and Bo Wu. “AutoMine: harmonizing high-level abstraction and high performance for graph mining.” Proceedings of the 27th ACM Symposium on Operating Systems Principles. 2019.

[2] Mawhirter, Daniel, et al. “GraphZero: Breaking Symmetry for Efficient Graph Mining.” arXiv preprint arXiv:1911.12877 (2019).

[3] Jamshidi, Kasra, Rakesh Mahadasa, and Keval Vora. “Peregrine: a pattern-aware graph mining system.” Proceedings of the Fifteenth European Conference on Computer Systems. 2020.

### BRIEF DESCRIPTION OF THE DRAWINGS

FIG. 1 shows an overall flow chart of a subgraph matching strategy determining method according to an embodiment of the present disclosure.

FIG. 2 shows a schematic process diagram of a subgraph matching method according to an embodiment of the present disclosure.

FIG. 3 shows an overall flow chart of a method 120 for generating a plurality of restriction sets R from a pattern p according to an embodiment of the present disclosure.

FIG. 4 shows a code example of an automorphism elimination algorithm according to an embodiment of the present disclosure.

FIG. 5 shows an example of an automorphism elimination algorithm given a pattern example according to an embodiment of the present disclosure.

FIG. 6 shows an overall flow chart of a method 130 for acquiring a plurality of search order schedules according to an embodiment of the present disclosure.

FIG. 7 shows an example of generating a pseudocode according to a configuration according to an embodiment of the present disclosure. Diagram (a) is a pattern and a configuration (a combination of a restriction set and a search order), and (b) is the pseudocode of the generated subgraph matching algorithm.

FIG. 8 shows an example of a pseudocode of using the Inclusion-Exclusion Principle for matched subgraph counting according to an embodiment of the present disclosure.

FIG. 9 shows patterns adopted in an experiment of comparison between the subgraph matching method according to the embodiment of the present disclosure and the prior art method.

FIG. 10 shows a comparison data graph of experimental results of the subgraph matching method when the Inclusion-Exclusion Principle is not used according to the embodiment of the present disclosure, as compared with the prior art method.

FIG. 11 shows a comparison data graph of experimental results of the subgraph matching method after the Inclusion-Exclusion Principle is used according to the embodiment of the present disclosure as compared with the subgraph counting method when the Inclusion-Exclusion Principle is not used according to the embodiment of the present disclosure.

### DETAILED DESCRIPTION

Embodiments of the present disclosure will be described in detail below in conjunction with the accompanying drawings.

Before description, meaning of the terms used herein is explained.

2-cycle: a cycle with a length of 2 in a form of product of disjoint cycles written from the permutation.

3-element ring: a ring consisting of three vertices.

The ith loop: unless otherwise specified, the ith loop is the ith loop of n loops from outside to inside of the subgraph matching algorithm; when the Inclusion-Exclusion Principle is used, if only the innermost k loops are considered, the ith loop is the ith loop of the innermost k loops from outside to inside of the n loops of the subgraph matching algorithm.

Permutation group: based on group theory, a permutation corresponding to each automorphism is written in the form of product of disjoint cycles, and all permutations corresponding to automorphisms form a permutation group.

Identity permutation: a permutation that transforms all elements into their own.

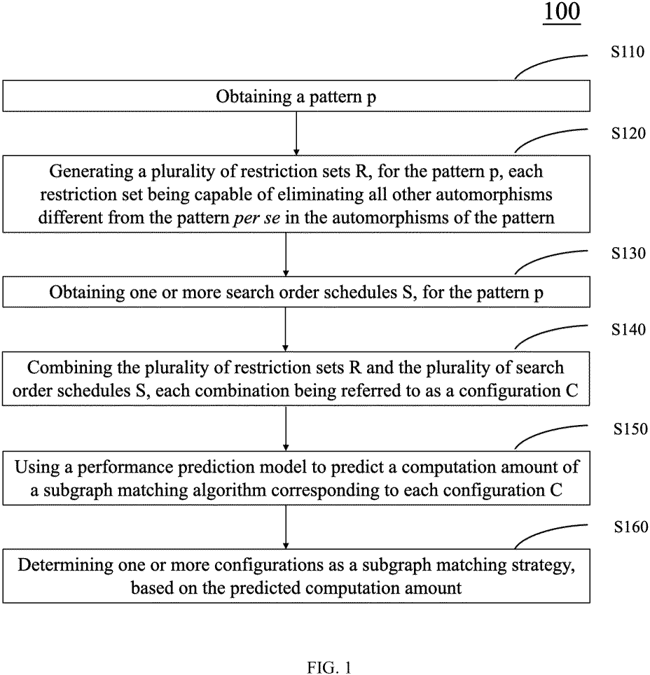

FIG. 1 shows an overall flow chart of a subgraph matching strategy determining method according to an embodiment of the present disclosure.

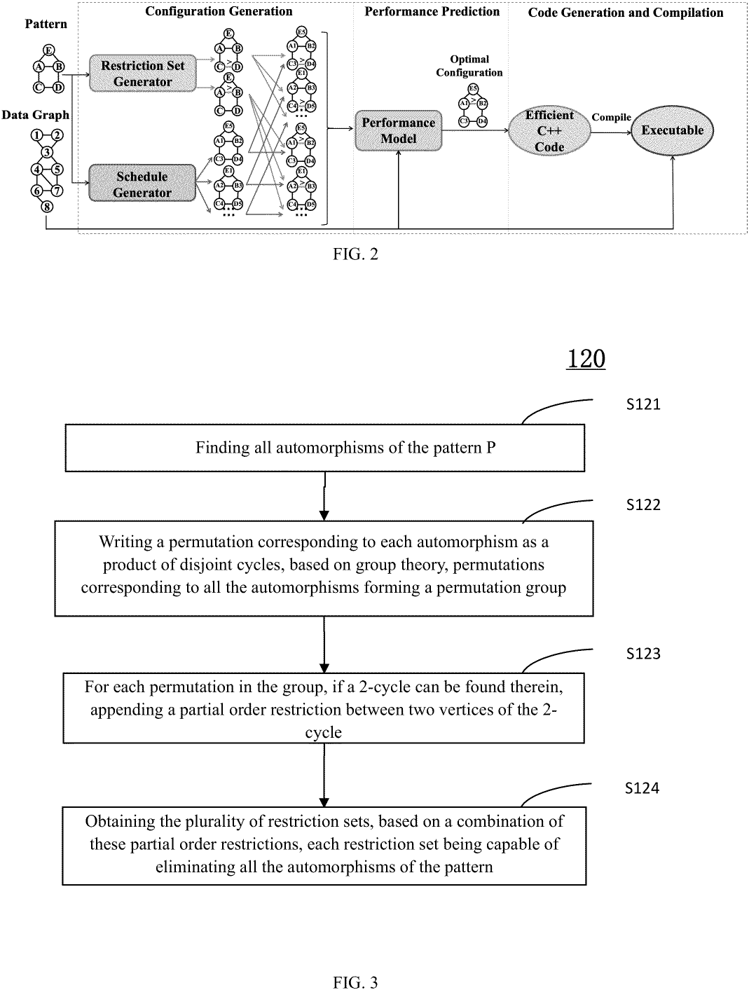

FIG. 2 shows a schematic process diagram of a subgraph matching method according to an embodiment of the present disclosure.

As shown in FIG. 1, in step S110, a pattern p is obtained.

For example, the pattern example in FIG. 2 is EACDB.

A pattern may be a subgraph of a graph externally specified or being mined. The pattern usually represents aspects that people are interested in, for example, a pattern representing fraud in fraud detection, a pattern representing friendship in social networks, and a pattern representing pyramid selling in pyramid selling networks.

In step S120, for the pattern p, a plurality of restriction sets R are generated, each restriction set is capable of eliminating all other automorphisms different from the pattern per se in the automorphisms of the pattern; wherein, each restriction set is capable of completely eliminating redundant computations caused by the automorphisms.

For example, the pattern p in FIG. 2 is expressed as [A, B, C, D, E], and two restriction sets are obtained, the first restriction set is C>D, and the second restriction set is A>B.

FIG. 3 shows an overall flow chart of a method 120 for generating a plurality of restriction sets R from a pattern p according to an embodiment of the present disclosure; and the method may be used for step S120 in FIG. 1.

In step S121, all the automorphisms of the pattern P are found.

In step S122, based on group theory, a permutation corresponding to each automorphisms is written in a form of product of disjoint cycles, and permutations corresponding to all the automorphisms found form a permutation group.

In step S123, for each permutation in the group, if a 2-cycle can be found therein, a partial order restriction is appended between two vertices of the 2-cycle.

In step S124, the plurality of restriction sets are obtained based on the combination of these partial order restrictions, wherein, each restriction set is capable of eliminating all automorphisms of the pattern.

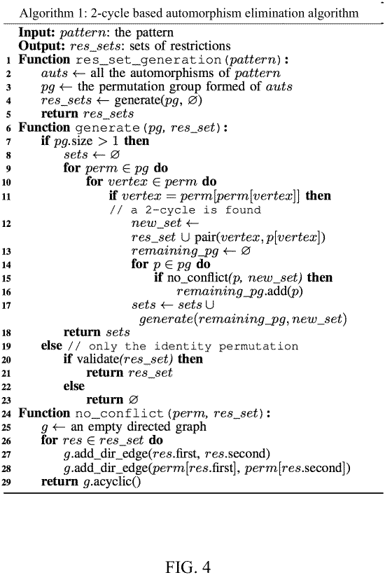

FIG. 4 shows a code example of an automorphism elimination algorithm according to an embodiment of the present disclosure.

In the algorithm shown in FIG. 4, the pattern is taken as an input, and the plurality of restriction sets are taken as an output, wherein, each restriction set is capable of completely eliminating redundant computations caused by automorphisms. The algorithm firstly generates all the automorphisms auts of the pattern and a permutation group pg corresponding thereto (lines 2 to 3). Then, a recursive function generate is called (line 4). If there are permutations other than an identity permutation in the group, more restrictions need to be added to eliminate the other permutations (line 7). For each permutation in the group, if a 2-cycle can be found therein, a partial order restriction is appended between the two vertices of the 2-cycle (lines 9 to 12). Next, a new set of restrictions is used to eliminate permutations (lines 13 to 16). In order to eliminate the remaining permutations, more restrictions are generated by calling the function of generate recursively (line 17). When there is only one identity permutation in the permutation group, we verify the current set of restrictions by calling the validate(res_set) function (lines 19 to 20). As an implementation example of the validate function, assuming that the pattern has n vertices, a subgraph matching algorithm is run with the current set of restrictions on an n-vertex complete graph as the data graph, and the number of subgraphs obtained is recorded as ans_{with}; then the subgraph matching algorithm is rerun without any restrictions on the n-vertex complete graph, and the number of subgraphs obtained is recorded as ans_{without}; if ans_{with} = ans_{without} /automorphisms_count, it is verified that the current restriction set is capable of correctly eliminating all redundant computations caused by automorphisms, where, automorphisms_count is the number of automorphisms of pattern p. The function of no conflict (lines 24 to 29) is used to verify whether a permutation can be eliminated by the current set of restrictions. Each restriction in each set is regarded as two directed edges in the algorithm and the two directed edges are added to an initially empty directed graph g. Specifically, assuming that two vertices of one restriction are respectively x and y, the current permutation is perm, then a directed edge is connected from x to y in g, that is, a directed edge is connected from perm[x] to perm[y]. A permutation is not eliminated if and only if g is a directed acyclic graph.

FIG. 5 shows an example of an automorphism elimination algorithm given a pattern example according to an embodiment of the present disclosure. In FIG. 5, (a) shows a rectangular pattern; (b) is an automorphism example of (a); (c) is a permutation group consisting of all automorphisms of (a), wherein, each automorphism is written in a form of disjoint cycles; (d) is a procedure of eliminating all the automorphisms in (c) and generating a plurality of restriction sets according to the restriction set generation algorithm shown in FIG. 4. Round 1, Round 2 and Round 3 in (d) respectively indicate remaining permutations in the permutation group, after appending 1, 2 and 3 restrictions to the restriction set and eliminating the permutations in the permutation group with restrictions in the restriction set, for example, ①②③⑤⑦⑧ in Round 1 indicates that after the restriction of id(B)>id(D) is appended to the restriction set, ④ and ⑥ in the original permutation group are eliminated, leaving only the 6 other permutations.

Returning to FIG. 1, in step S130, for pattern p, a plurality of search order schedules S are obtained.

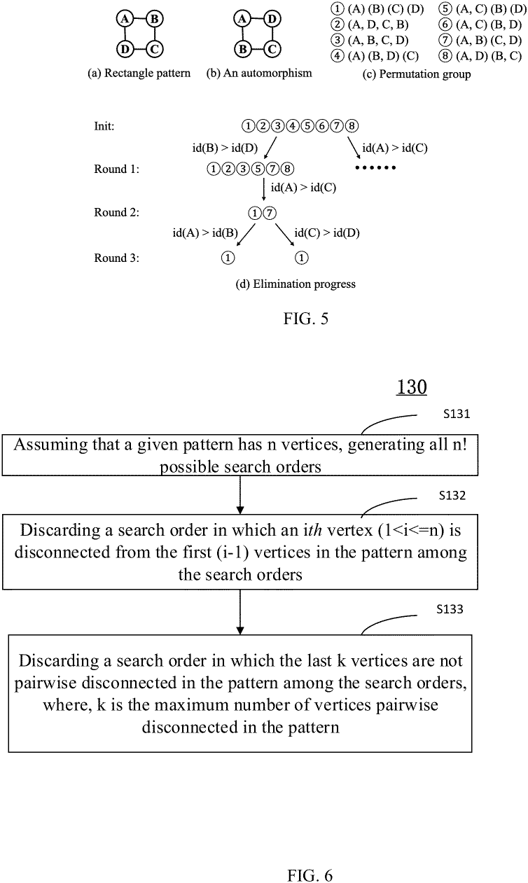

FIG. 6 shows an overall flow chart of a method 130 for acquiring a plurality of search order schedules according to an embodiment of the present disclosure; and the method 130 may be used in step S130 in FIG. 1.

In step S131, it is assumed that a given pattern has n vertices, and all n! possible search orders are generated.

In step S132, a search order in which an ith vertex (1<i<=n) is disconnected from the first (i-1) vertices in the pattern is discarded among the search orders.

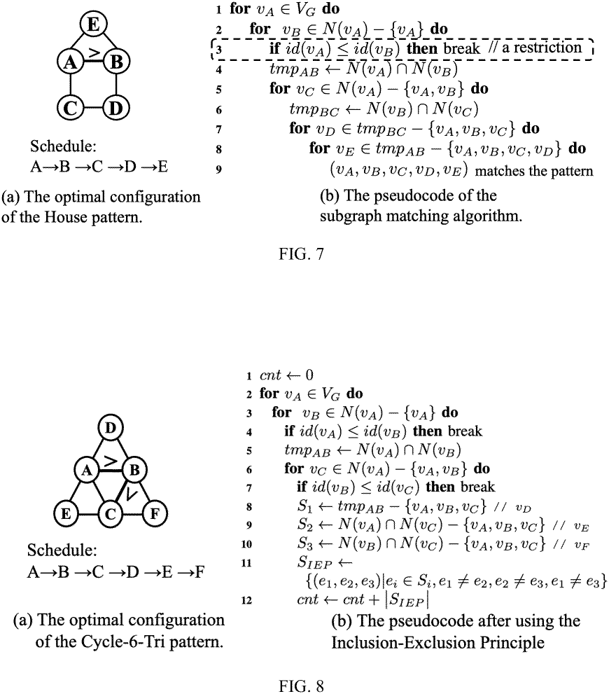

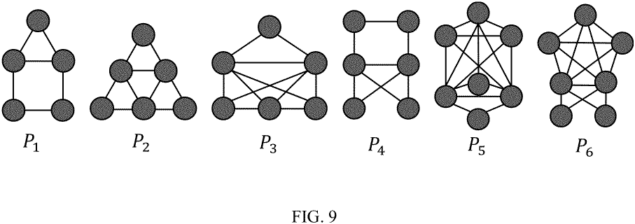

FIG. 7 shows an example of generating a pseudocode according to a configuration according to an embodiment of the present disclosure. Diagram (a) is a pattern and a configuration (a combination of a restriction set and a search order), and (b) is the pseudocode of the generated subgraph matching algorithm. V_{G} is a vertex set in the data graph, and N(v) returns the neighborhood of v in the data graph.

For example, in FIG. 7 (a), assuming that the first two vertices in the search order are C and D, then if the third searched vertex is E, the search order will be discarded, because E is not connected with C or D, that is, the first three vertices in the search order are not connected.

In step S133, a search order in which the last k vertices are not pairwise disconnected in the pattern is discarded among the search orders, where, k is the maximum number of vertices pairwise disconnected in the pattern.

For example, in FIG. 7 (a), k=2, so the search orders in which the last two vertices are connected by edges shall all be discarded among the search orders.

Having undergone the above two phases of filtering, the remaining search orders are efficient search orders.

It should be noted that the search order schedule obtaining method above is given as an example according to the preferred mode of the embodiments of the present disclosure, rather than indicating that the search order schedule that may be adopted by the present disclosure is limited thereto, and other search order schedule obtaining methods may also be used.

Returning to FIG. 1, in step S140, the plurality of restriction sets R and the plurality of search order schedules S are combined, and each combination is referred to as a configuration C;

For example, two restriction sets R and three search order schedules may render six types of combinations, namely, six configurations.

Based on each configuration, a subgraph matching code may be obtained by programing.

For example, a configuration example is given in FIG. 7 (a), that is, a configuration consisting of a restriction A>B of House pattern P and a search schedule A->B->-C>-D>-E. FIG. 7 (b) shows a subgraph matching pseudocode corresponding to the configuration of FIG. 7 (a) according to an embodiment of the present disclosure, where, V_{G} is a vertex set in the data graph. N(v) returns the neighborhood of vertex v in the data graph.

In step S150, a performance prediction model is used to predict a computation amount of a subgraph matching algorithm corresponding to each configuration C.

Each configuration has a corresponding subgraph matching code, and the performance prediction model predicts performance of the code. As described above, FIG. 7 (b) shows an example of the subgraph matching pseudocode corresponding to FIG. 7 (a) according to the embodiment of the present disclosure.

The inventor believes that the performance of the subgraph matching algorithm is mainly affected by three factors: a size of the set where the loop traverses, a probability of exiting the loop due to failure to meet a restriction, and a cost of computing intersection of two sets.

According to an embodiment of the present disclosure, the inventor has designed a performance model below:

$${\text{cost}}_{i} = \left\{\begin{matrix}{l}_{i} \times \left(1 - {f}_{i}\right) \times \left({c}_{i} + c o s {t}_{i + 1}\right) , \\ {l}_{i} \times \left(1 - {f}_{i}\right) ,\end{matrix}\right) \begin{matrix}f o r 1 \leq i \leq n - 1 \\ f o r i = n\end{matrix}$$

Where, n is the number of vertices in the pattern, costᵢ is the total cost of the ith loop, lᵢ is the number of loops (i.e., a size of a set where a loop traverses), fᵢ is the probability that one subgraph is filtered out by a restriction, and cᵢ is the computation overhead of the intersection operations.

An important innovation of the embodiment of the present disclosure lies in estimation of a set size of intersection of neighbor sets of a plurality of nodes, and the set size of intersection will directly affect lᵢ and cᵢ, thereby indirectly affecting costᵢ. With respect to estimation of the set size of intersection, the embodiment of the present disclosure creatively adopts a method below: a set size of intersection of n neighbor sets is

$$\left|{\text{V}}_{G}\right| \times {\text{p}}_{1} \times {p}_{2}^{n - 1} ,$$

where,

$${\text{p}}_{1} = \frac{2 \times \left|{E}_{G}\right|}{{\left|{V}_{G}\right|}^{2}} , {\text{p}}_{2} = \frac{t r i \_ c n t \times \left|{V}_{G}\right|}{{\left(2 \times \left|{E}_{G}\right|\right)}^{2}} ,$$

and E_{G}, V_{G}, tri_cnt are respectively the numbers of edge sets, vertex sets and 3-element ring subgraphs in the data graph.

It should be noted that the above-described performance prediction model example is a preferred example designed by the inventor to predict performance of a configuration consisting of a restriction set and a search order, and as shown in experimental results below, outstanding technical effects have been achieved as compared with the prior art. However, this does not mean that the present disclosure can only use the performance prediction model, on the contrary, other performance prediction models may be designed and used as required.

Returning to FIG. 1, in step S160, a configuration as a subgraph matching strategy is determined, based on the predicted computation amount.

The subgraph matching strategy determining method according to the preferred embodiment of the present disclosure is described above; in practical application, the subgraph matching strategy determining method may be used to obtain the subgraph matching strategy; and the obtained subgraph matching strategy is used to find a subgraph matching the pattern p in the data graph.

Such subgraph matching strategy determining method and subgraph matching method may be applied to social networks, bioinformatics, and fraud detection, etc.

The subgraph matching method for eliminating redundant computations according to the embodiment of the present disclosure adopts a 2-cycle based restriction generation algorithm, which may generate a variety of different restriction sets, each of which is capable of completely eliminating automorphisms, and performance caused by using different sets is different, which also provides more possible optimization opportunities for subsequent performance prediction; in the 2-phase search order generating method, some search orders whose performance is obviously low may be discarded in advance to reduce the cost of the performance prediction phase; the performance prediction model based on the 3-element ring may predict performance of different configurations more accurately, so as to reduce redundant computations in the subgraph matching algorithm.

In some applications, which only need counting the number of subgraphs matching the pattern in the graph data, but not caring about the specific subgraph matching the pattern, the inventor proposes a subgraph counting schedule by using the Inclusion-Exclusion Principle to directly count, so as to reduce redundant computations, wherein, the innermost k loops are counted directly, instead of listing the innermost k loops sequentially, which is based on the inventor’s discovery below: in the 2-phase search order generating method according to the above-described embodiments of the present disclosure, the last k vertices searched in the search order of the optimal configuration are not connected by edges, so the innermost k loops in the multi-layer nested loops have no dependence; and therefore, the Inclusion-Exclusion Principle may be used to directly count to reduce redundant computations.

FIG. 8 shows an example of a pseudocode of using the Inclusion-Exclusion Principle for matched subgraph counting according to an embodiment of the present disclosure. Without losing generality, let Sᵢ be a loop set corresponding to the ith vertex in the last k vertices; as shown in FIG. 8, in the pattern shown in (a), since there is no edge connected between D, E and F, k=3; while in the last three vertices of the search order, D is the first vertex, and D is connected with A and B, so S₁ = N (A) ∩ N(B) - {ν_{A}, ν_{B}, ν_{C}}, where, the cause of “-{ν_{A}, ν_{B}, ν_{C}}” is that D must be a vertex different from A, B, C. In order to count quickly and meanwhile meet the requirement of “all vertices in the subgraph are different”, it is defined:

$$\begin{matrix}{\text{S}}_{I E P} = \left\{\left({e}_{1} , {e}_{2} , … , {e}_{k}\right) \left|∀ 1 \leq i \leq \text{k}\right) \text{s} \text{.t} \text{.} {\text{e}}_{i} ∈ {S}_{i} a n d ∀ 1 \leq i , j \leq \right) \\ \left(k s . t . {e}_{i} \neq {e}_{j}\right\} .\end{matrix}$$

S_{IEP} means that each element (of the k-element group) and the first (n-k) vertices that have been determined (e.g., in FIG. 8, the first (n-k) vertices that have been determined are ν_{A}, ν_{B}, ν_{C}) are capable of forming a subgraph matching the pattern. Therefore, counting the matched subgraph is equivalent to calculating a set size of S_{IEP}. A complement transforming method is used, to obtain:

$${\text{S}}_{I E P} = {\text{S}}_{1} \times {\text{S}}_{2} \times … \times {\text{S}}_{k} - \left\{\left({e}_{1} , {e}_{2} , … , {e}_{k}\right) \left|∃ 1 \leq i , j \leq k s . t . {e}_{i} = {e}_{j}\right)\right\} .$$

The set size of S₁ × S₂ × ... × Sₖ can be directly calculated according to the multiplication principle, while the set size of {(e₁, e₂, ...,eₖ|∃1 ≤ i, j ≤ k s.t. eᵢ = eⱼ} can be calculated through the Inclusion-Exclusion Principle. The set size of S_{IEP} can be obtained by subtracting the two.

The present disclosure may further be implemented as a computing device and a computer readable storage medium.

According to another aspect of the present disclosure, there is provided a computing device including: a processor; and a memory, having computer executable instructions stored thereon; wherein, the instructions, when executed by the processor, execute any one of the subgraph matching strategy determining method, the subgraph matching method and the subgraph counting method as described above.

According to another aspect of the present disclosure, there is provided a computer readable storage medium, having computer executable instructions stored thereon; wherein, the instructions, when executed by the processor, execute any one of the subgraph matching strategy determining method, the subgraph matching method and the subgraph counting method as described above.

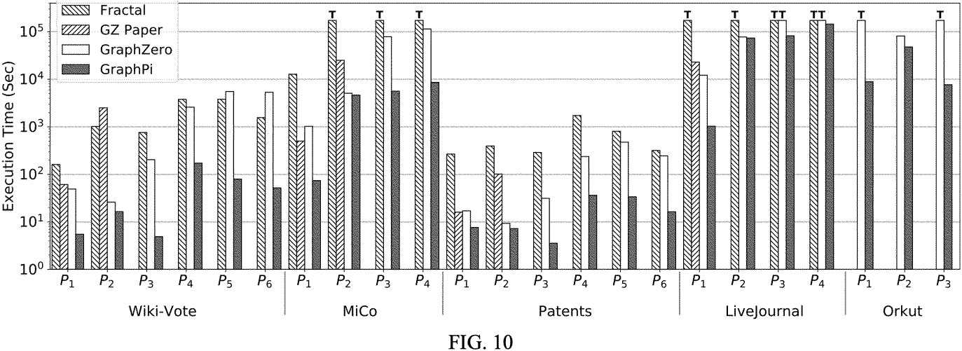

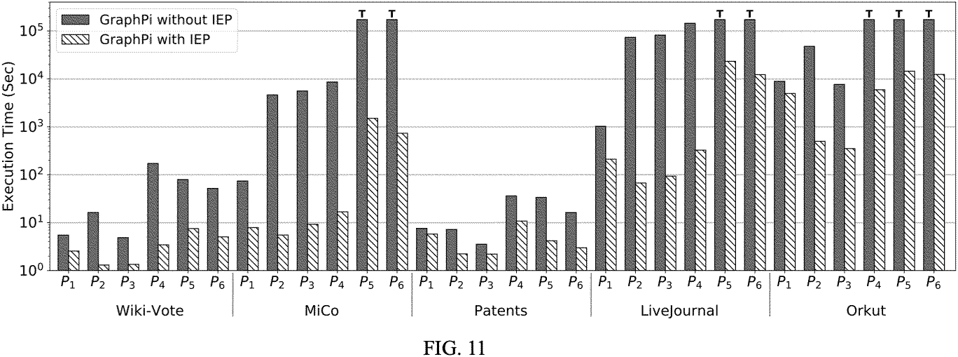

In order to verify the effect of the subgraph matching strategy determining method and subgraph matching method according to the embodiment of the present disclosure, we designed and carried out a series of experiments to compare the methods with the existing methods. In the experiment, 6 complex patterns (as shown in FIG. 9) and 5 real-world data graphs were used. FIG. 10 shows superior performance of the subgraph matching method when the Inclusion-Exclusion Principle is not used according to the embodiment of the present disclosure as compared with the prior art method. It may be seen that the subgraph matching method according to the embodiment of the present disclosure is at most 106 times faster than GraphZero and 154 times faster than Fractal. With respect to a case where only the matched subgraphs need to be counted, FIG. 11 shows that the subgraph matching method after the Inclusion-Exclusion Principle is used according to the embodiment of the present disclosure is 1110 times faster than the subgraph counting method when the Inclusion-Exclusion Principle is not used according to the embodiment of the present disclosure.

The descriptions of the respective embodiments of the present disclosure have been presented for purposes of illustration, but are not intended to be exhaustive or limited to the respective embodiments disclosed. Many modifications and variations will be apparent to those of ordinary skill in the art without departing from the scope and spirit of the described respective embodiments. Therefore, the scope of the present disclosure should be the scope of the following claims.

1. A subgraph matching strategy determining method for finding all subgraphs matching a pattern p in a data graph, comprising:
obtaining a pattern p;
generating a plurality of restriction sets R, for the pattern p, each restriction set being capable of eliminating all other automorphisms different from the pattern per se in the automorphisms of the pattern;
obtaining a plurality of search order schedules S, for the pattern p;
combining the plurality of restriction sets R and the plurality of search order schedules S, each combination being referred to as a configuration C;
using a performance prediction model to predict a computation amount of a subgraph matching algorithm corresponding to each configuration C, and
determining a configuration as a subgraph matching strategy, based on the predicted computation amount.

2. The subgraph matching strategy determining method according to claim 1, wherein, the determining a configuration as a subgraph matching strategy, based on the predicted computation amount, comprises:
determining a configuration with a minimum computation amount as the subgraph matching strategy.

3. The subgraph matching strategy determining method according to claim 1, wherein, the generating a plurality of restriction sets R, comprises:
finding all automorphisms of the pattern P;
writing a permutation corresponding to each automorphism as a product of disjoint cycles, based on group theory, permutations corresponding to all the automorphisms forming a permutation group;
for each permutation in the group, if a 2-cycle can be found therein, appending a partial order restriction between two vertices of the 2-cycle; and
obtaining the plurality of restriction sets, based on a combination of these partial order restrictions, each restriction set being capable of eliminating all the automorphisms of the pattern.

4. The subgraph matching strategy determining method according to claim 1, wherein, the generating a plurality of restriction sets R, comprises:
step 1: finding all the automorphisms of the pattern P,
step 2: writing a permutation corresponding to each automorphism in a form of product of disjoint cycles, based on group theory, permutations corresponding to all the automorphisms forming a permutation group;
step 3: selecting a 2-cycle of a permutation in the permutation group;
step 4: appending a partial order restriction between two vertices of the selected 2-cycle, and appending the partial order restriction to the current restriction set;
step 5: using the current restriction set, to eliminate some permutations in the permutation group;
step 6: repeating steps 3 to 5 until there is only one permutation in the permutation group;
step 7: verifying correctness of the current restriction set; if correct, a validate restriction set is found; and
step 8: repeating steps 3 to 7 by traversing all 2-cycles in the group.

5. The subgraph matching strategy determining method according to claim 4, wherein, the using the current restriction set, to eliminate some permutations in the permutation group in step 5 comprises:
for each permutation perm in the permutation group, judging whether the permutation can be eliminated by the current restriction set, comprising:
for each restriction in the current restriction set, regarding the restriction as two directed edges and adding the two edges to an initially empty directed graph g, representing the two vertices of the restriction respectively as x and y, then connecting a directed edge from vertex x to vertex y in the directed graph g, that is, connecting a directed edge from perm[x] to perm[y];
if the directed graph g is a directed acyclic graph, the permutation perm is not eliminated; otherwise, the permutation perm is eliminated.

6. The subgraph matching strategy determining method according to claim 3, further comprising: verifying whether a restriction set is validate; if validate, preserving the restriction set; otherwise, discarding the restriction set.

7. The subgraph matching strategy determining method according to claim 6, wherein, the verifying whether a restriction set is validate, comprises:
assuming that the pattern p comprises n vertices, executing the subgraph matching algorithm with the restriction set on a complete graph of n vertices, recording the number of subgraphs obtained as ans_{with};
executing the subgraph matching algorithm without any restriction on the complete graph of n vertices, recording the number of subgraphs obtained as ans_{without};
if ans_{with} = ans_{without} /automorphisms_count, it is verified that the current restriction set is capable of correctly eliminating all redundant computations caused by automorphisms, and is validate; otherwise, the restriction set is invalidate, where, automorphisms_count is the number of automorphisms of the pattern p.

8. The subgraph matching strategy determining method according to claim 1, wherein, the obtaining a plurality of search order schedules S, for the pattern p comprises:
assuming that a given pattern has n vertices, generating all n! possible search orders;
discarding a search order in which an ith vertex (1<i<=n) is disconnected from the first (i-1) vertices in the pattern among the search orders; and
discarding a search order in which the last k vertices are not pairwise disconnected in the pattern among the search orders, where, k is the maximum number of vertices pairwise disconnected in the pattern.

9. The subgraph matching strategy determining method according to claim 1, wherein, the performance prediction model is based on a 3-element ring, and estimation of a set size of an intersection of a plurality of sets needs to be used, wherein, a set size of an intersection of n neighbor sets is estimated as:
$$\left|{\text{V}}_{G}\right| \times {\text{p}}_{1} \times {p}_{2}^{a - 1} ,$$
where,
$${\text{P}}_{1} = \frac{2 \times \left|{E}_{G}\right|}{{\left|{V}_{G}\right|}^{2}} , {\text{P}}_{2} = \frac{\text{crt\_enc} \times \left|{V}_{G}\right|}{{\left(2 \times \left|E {}_{2}\right|\right)}^{2}} , \text{and} {\text{E}}_{G x} {\text{V}}_{G} t r l \_ e n t$$
are respectively the numbers of edge sets, vertex sets and 3-element ring subgraphs in the data graph.

10. The subgraph matching strategy determining method according to claim 9, wherein, the performance prediction model is:
$${\text{cost}}_{1} = \left\{\begin{matrix}{l}_{i} \times \left(1 - {f}_{i}\right) \times \left({c}_{i} + c o s {t}_{i + 1}\right) , f o r 1 \leq t \leq n - 1 \\ {l}_{l} \times \left(1 - {f}_{i}\right) , f o r t = n\end{matrix}\right)$$
where, n is the number of vertices in the pattern, costᵢ is a total cost of the ith loop, Iᵢ is the loop size, fᵢ is a probability that one subgraph is filtered out by a restriction, cᵢ is computation overhead of intersection operations, and in the computation of lᵢ and cᵢ, the set size of the intersection of a plurality of sets is estimated.

11. A subgraph matching method for searching a subgraph matching a pattern p in a data graph, comprising:
obtaining a subgraph matching strategy by using the subgraph matching strategy determining method according to claim 1; and
using the obtained subgraph matching strategy to find the subgraph matching the pattern p in the data graph.

12. The subgraph matching method according to claim 11, wherein, the subgraph matching method is applied to social networks, bioinformatics, and fraud detection.

13. A subgraph counting method for determining the number of subgraphs matching a pattern p in a data graph, comprising:
obtaining a subgraph matching strategy by using the subgraph matching strategy determining method according to claim 8; and
using Inclusion-Exclusion Principle for counting, considering that there is no edge connected between the last k vertices searched in the pattern, and in a corresponding subgraph matching strategy, there is no dependence between the last k loops.

14. The subgraph counting method according to claim 13, wherein, let Sᵢ be a loop set corresponding to the ith vertex in the last k vertices,
$$\begin{matrix}{S}_{I E P} = \\ \left\{\left(\left({e}_{1} , {e}_{2} , … , {e}_{k}\right| ∀ 1 \leq t \leq \text{k} \text{s} \text{.t} \text{.} {e}_{i} ∈ {S}_{i} a n d ∀ 1 \leq t , j \leq k s . t . {e}_{i} \neq {e}_{l}\right)\right\}\end{matrix}$$
S_{IEP}, means that each element of a k-element group consisting of the k vertices and the first (n-k) vertices that have been determined are capable of forming a subgraph matching the pattern, so counting the matched subgraph is equivalent to calculating a set size of S_{IEP};
a complement transforming method is used, to obtain:
$${\text{S}}_{I E P} = {\text{S}}_{1} \times {\text{S}}_{2} \times … \times {\text{S}}_{\text{k}} - \left\{\left(\left({e}_{1} , {e}_{2} , … {e}_{k}\right| ∃ 1 \leq l , j \leq k s . t . {e}_{t} = {e}_{l}\right)\right\} .$$
a set size of S₁ × S₂ × _ × Sₖ may be directly calculated according to the multiplication principle, while a set size of {(∈₁/∈₂, - ∈ₖ|31 ≤ t, j ≤ k s.t.∈₁ = ∈_{I}} may be calculated through the Inclusion-Exclusion Principle, and the set size of S_{IEP} may be obtained by subtracting the two.

15-16. (canceled)
